(19) United States
(12) Patent Application Publication
(10) Pub. No.: US 2026/0268553 A1
(43) Pub. Date: Sep. 10, 2026

(54) TEXT-TO-IMAGE GENERATION USING PER-LAYER CONDITIONING

(71) Applicant: Google LLC, Mountain View, CA (US)

(72) Inventors: Andrey Voynov, Tel-Aviv (IL); Qinghao Chu, Menlo Park, CA (US); Kfir Aberman, San Mateo, CA (US); Daniel Cohen-Or, Hod Hasharon (IL)

(21) Appl. No.: 19/165,779

(22) PCT Filed: Mar. 18, 2024
(86) PCT No.: PCT/US2024/020421

§ 371 Date: Sep. 16, 2025

Related U.S. Application Data
(60) Provisional application No. 63/452,652, filed on Mar. 16, 2023.

(51) Int. Cl. G06T 11/60; G06N 3/0455; G06N 3/0475; G06T 5/70

(52) U.S. Cl. CPC G06T 11/60; G06N 3/0455; G06N 3/0475; G06T 5/70; G06T 2207/20182

(57) ABSTRACT

Methods, systems, and apparatus, including computer programs encoded on computer storage media, for generating an output image using a diffusion model and conditioned on conditioning inputs from an extended conditioning space. The diffusion model includes a first neural network layer followed by a second neural network layer. At each of multiple time steps, the first neural network layer receives a first conditioning input, and the second neural network layer receives a second conditioning input that is different from the first conditioning input.

### CROSS-REFERENCE TO RELATED APPLICATION

This application claims priority to U.S. Provisional Application No. 63/452,652, filed on Mar. 16, 2023. The disclosure of the prior application is considered part of and is incorporated by reference in the disclosure of this application.

### BACKGROUND

This specification relates to processing images using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates an output image from an input. For example, the input may include input text submitted by a user of the system specifying a particular class of objects or a particular object that should appear in the output image, and the system can generate the output image conditioned on that input text, i.e., generate the output image that shows an object belonging to the particular class or the particular object. Moreover, the input text may additionally describe the desired characteristics, e.g., the appearance, color, shape, or texture, of an object, and the system can generate the output image that shows the object having the desired characteristics.

Particular embodiments of the subject matter described in this specification can be implemented so as to realize one or more of the following advantages.

The extended conditioning space as described in this specification can enhance the performance of any of a variety of diffusion models that are configured to generate images with no or minimal additional computational overhead devoted to the training of these diffusion models. By conditioning each of multiple layers of a diffusion model on a different conditioning input within the space when using the diffusion model to generate output images, e.g., from an input prompt that includes text, the expressiveness, preciseness, or both of the output images can be improved. Moreover, the extended conditioning space permits greater controllability over the content of the output images, thus making it easier to modify certain aspects of an object shown in an output image. For example, conditioning input relating to different characteristics, e.g. color, shape, texture, object class, may be provided to different layers of the diffusion model to enable the model to learn to separate those characteristics by layer. This enables greater control of the model's generation process and improves the model's ability to generate images according to desired characteristics specified in an input prompt.

Advantageously, when applying textual inversion to enable diffusion models to generate output images that are either a blend of respective aspects of two or more input images, or output images that show a particular subject instance of an object class (rather than variable subject instances of the object class), a diffusion model associated with the described extended conditioning space can converge significantly faster than those that use a standard conditioning space, where different layers of the model share a common conditioning input when generating an output image. Textual inversion using the extended conditioning space thus consumes reduced consumption of computational resources, e.g., reduced processor cycles, reduced memory, and reduced power consumption.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A-B show an example image generation system.

FIG. 2 illustrates a comparison between conventional conditioning for a diffusion model and per-layer conditioning for a diffusion model.

FIG. 3 is a flow diagram of an example process for generating an output image.

FIG. 4 is a flow diagram of an example process for generating a conditioning input.

FIG. 5 is a flow diagram of another example process for generating a conditioning input.

FIG. 6 is a flow diagram of example process for updating an intermediate representation of the output image.

Like reference numbers and designations in the various drawings indicate like elements.

### DETAILED DESCRIPTION

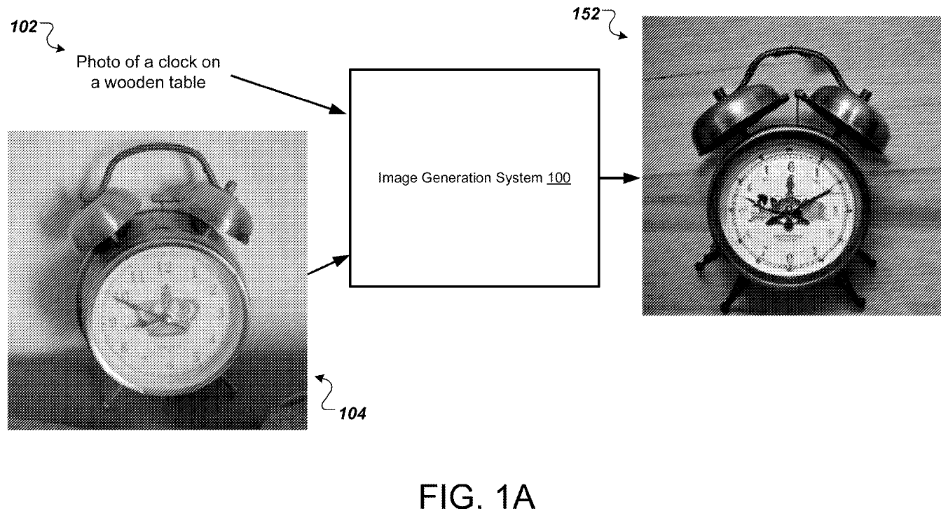

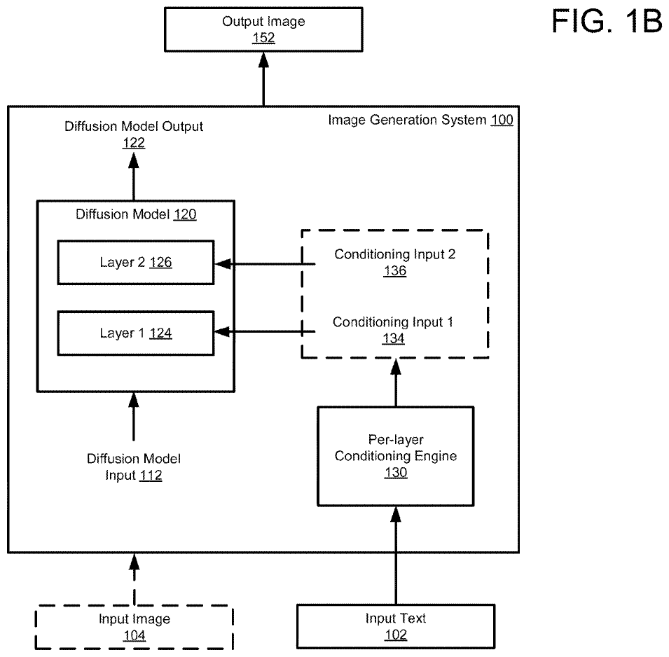

FIGS. 1A-B show an example image generation system 100. The image generation system 100 is an example of a system implemented as computer programs on one or more computers in one or more locations in which the systems, components, and techniques described below are implemented.

The image generation system 100 obtains a system input that includes input text 102 and, in some implementations, one or more input images 104, and generates an output image 152 conditioned on the system input. As used herein, the term “image” can mean a digital image, such as a two-dimensional image or a three-dimensional image, or even consecutive frames of video. An image can have multiple pixels, where each pixel can have multiple values.

Generally, the input text 102 describes one or more aspects for the output image 152. For example, the input text 102 may include text that specifies a particular object that should appear in the output image 152. As another example, the input text 102 may include text that specifies a particular class of objects from a plurality of object classes to which an object depicted in the output image 152 should belong.

Moreover, the input text 102 may additionally describe the desired visual characteristics, e.g., the appearance, color, shape, or texture, of an object, such that the output image 152 shows the object having the desired visual characteristics.

As yet another example, when the system input also includes an input image 104, the input text 102 may include text that defines adjustments or modifications that should be made to the input image 104 to generate the output image 152, such that the output image 152 is a modified version of the input image 104.

As illustrated in FIG. 1A, the image generation system 100 receives the following as input text 102: “photo of a clock on a wooden table” and an input image 104 which depicts a clock. The image generation system 100 then uses the input text 102 and the input image 104 to generate an output image 152 which depicts a clock on a wooden table.

As illustrated in FIG. 1B, to generate the output image 152, the image generation system 100 uses a diffusion model neural network 120 (or “a diffusion model 120” for short) and a per-layer conditioning engine 130 to generate the output image 152 across multiple time steps by performing a reverse diffusion process that is guided by the conditioning inputs generated by the per-layer conditioning engine 130.

The diffusion model 120 can have any appropriate neural network architecture that can be configured through training to, at any given time step, process a diffusion model input 112 for the given time step that includes a current intermediate representation of the output image (as of the given time step) to generate a diffusion model output 122 for the given time step from which an updated intermediate representation of the output image can be inferred.

For example, the diffusion model 120 can have been trained, e.g., by the image generation system 100 or another training system, on a training set of images using a denoising score-matching objective or a variational lower bound objective to generate the diffusion model output 122.

If the given time step is the first time step in the reverse diffusion process, the current intermediate representation can be an initial intermediate representation, e.g., an initial intermediate representation that is generated based on sampling each value for the output image, e.g., in a pixel space or a latent space, from a predetermined noise distribution. For any subsequent time step, the current intermediate representation is the updated intermediate representation that has been generated in the immediately preceding time step.

The diffusion model output 122 can either define the updated intermediate representation directly, e.g., where the diffusion model output includes a prediction of the updated intermediate representation, or indirectly, e.g., where the diffusion model output includes a prediction of the noise component in the current intermediate representation. For example, the diffusion model output 122 can define a prediction of a noise that needs to be added to the output image 152 being generated by the system 100, to generate the current intermediate representation, and the updated intermediate representation is generated by using the predicted noise to de-noise the current intermediate representation, i.e., by removing the predicted noise from the current intermediate representation.

After the last time step in the reverse diffusion process, the output image 152 can be generated based on the updated intermediate representation obtained in the last time step. In some implementations, the image generation system 100 directly outputs the updated intermediate representation as the final output image 152. In other words, the output image 152 is the updated intermediate representation generated in the last time step of the multiple time steps in the reverse diffusion process.

In some other implementations, the image generation system 100 processes the updated intermediate representation generated in the last time step using a decoder neural network, e.g., a decoder neural network that has been trained jointly with the encoder neural network that was used to generate the initial intermediate representation based on optimizing an autoencoder objective function, to generate a decoder output and then uses the decoder output as the final output image 152.

For example, the image generation system 100 can provide the output image 152 for presentation to a user on a user computer, e.g., as a response to the user who submitted the input text 102. As another example, the image generation system 100 can store the output image 152 in a repository for later use.

In some implementations, the diffusion model 120 has a U-net architecture. For example, the U-net architecture can be any one of the architectures described in Aditya Ramesh, et al. Hierarchical text-conditional image generation with clip latents. arXiv preprint arXiv: 2204.06125, Robin Rombach, et al. High-resolution image synthesis with latent diffusion model, and Chitwan Saharia, et al. Photorealistic text-to-image diffusion models with deep language understanding. arXiv preprint arXiv: 2205.11487, 2022, to name just a few examples.

In some other implementations, the diffusion model 120 has a different architecture. Examples of those architectures include Diffusion Transformer (DiT) architectures and Universal Vision Transformer (UViT) architectures. For example, the DiT architecture is described in William Peebles, et al. Scalable diffusion models with transformers. Proceedings of the IEEE/CVF International Conference on Computer Vision. 2023, and the UVIT architecture is described in Wuyang Chen, et al. A simple single-scale vision transformer for object localization and instance segmentation. arXiv preprint arXiv: 2112.09747, 2021.

In any of these implementations, the diffusion model 120 has multiple neural network layers and generates the updated intermediate representation by performing a forward pass of the diffusion model input through the multiple neural network layers. The updated intermediate representation is thus generated from the output of the last layer in the diffusion model.

The multiple layers of the diffusion model 120 include a first neural network layer 124 followed by a second neural network layer 126. In some implementations, the second neural network layer 126 immediately follows the first neural network layer 124, where the output of the first neural network layer 124 will be received as input by the second neural network layer 126. In other implementations, the second neural network layer 126 and the first neural network layer 124 are separated by one or more other layers, such that the output of the first neural network layer 124 will be processed by the one or more other layers, and then the output(s) of the one or more other layers will be provided as input to the second neural network layer 126.

For example, the first neural network layer 124 and the second neural network layer 126 can each be a respective attention layer that applies an attention mechanism over a layer input to generate a layer output. As a particular example, the first neural network layer 124 (or, analogously, the second neural network layer 126) can be a cross-attention layer that generates a corresponding layer output by applying a cross-attention mechanism over a layer input.

As another example, the first neural network layer 124 can be an attention layer while the second neural network layer 126 can be a fully connected layer or a convolutional layer that operates on a layer input to generate a layer output according to the layer configuration.

As another example, the first neural network layer 124 and the second neural network layer 126 can each be a respective fully connected layer or a convolutional layer that operates on a layer input to generate a layer output according to the layer configuration.

In any of these examples, the layer input for the first neural network layer 124 can include both a conditioning input and the output of a preceding layer in the diffusion model 120. Likewise, the layer input for the second neural network layer 126 can include both a conditioning input and the output of a preceding layer in the diffusion model 120.

Although only two neural network layers are depicted in FIG. 1B for convenience, as mentioned above the diffusion model 120 generally includes many other layers, including, for example, convolution layers, pooling layers, embedding layers, and other attention layers, e.g., self-attention layers, or cross-attention layers, where each of some of these other layers can be configured to receive a layer input that includes both a conditioning input and the output of a preceding layer in the diffusion model 120.

In particular, at each time step, the image generation system 100 conditions different neural network layers on different conditioning inputs selected from an extended conditioning space, i.e., provides different conditioning inputs to different layers.

FIG. 1B thus illustrates that the image generation system 100 provides a first conditioning input 134 to the first neural network layer 124 and a second conditioning input 136 to the second neural network layer 126, where the second conditioning input is different from the first conditioning input.

A “conditioning input” as used in this specification is given in the form of one or more embeddings. An “embedding” can be a vector or another data structure (e.g., a matrix or a tensor) of numeric values, e.g., floating point values or other values, having a pre-determined dimensionality. Thus the first conditioning input 134 can differ from the second conditioning input 136 in that they include different numeric values.

The space of possible embeddings having the pre-determined dimensionality is referred to as the “extended conditioning space.” The conditioning space is “extended” because instead of having one single embedding that is shared by all layers of the diffusion model 120, this conditioning space includes a respective embedding for each of multiple layers of the diffusion model 120.

This is in contrast to some conventional image generation systems which provide the same conditioning input to different layers of a diffusion model. As explained throughout the specification, such an extended conditioning space is more expressive, provides greater disentangling, and thus provides better control over the output images 152 that are being generated by the image generation system 100.

Moreover, the extended conditioning space generally enhances the performance of a diffusion model 120 in image generation because it better accommodates the scenarios where different layers of the diffusion model 120 have varying degrees of control over the attributes of the output images 152, e.g., in a scenario where one layer has greater control over the geometric attributes (e.g., shape or size attributes) of an object depicted in an output image, while another layer has greater control over the stylistic attributes (e.g., color or texture attributes) of the output image.

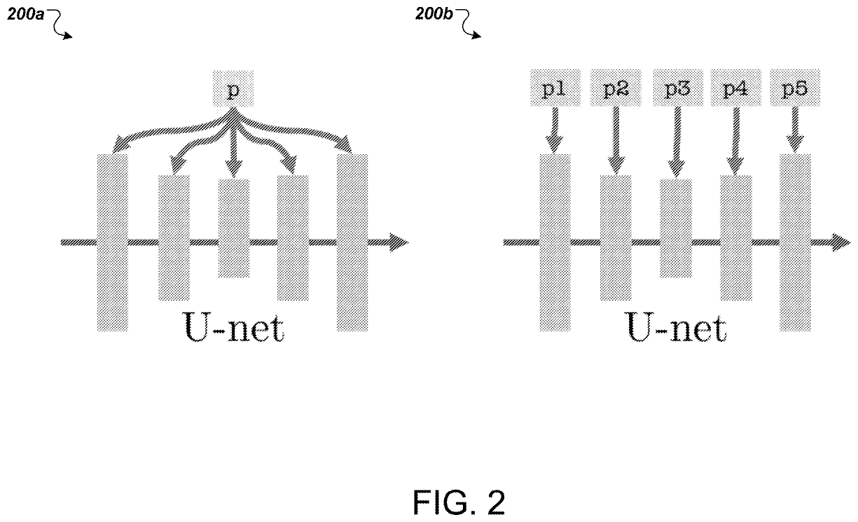

FIG. 2 illustrates a comparison between conventional conditioning for a diffusion model and per-layer conditioning for a diffusion model. In FIG. 2, diagram 200a shows conventional conditioning where a single embedding p is provided as (part of) inputs to different layers of a diffusion model that has a U-net architecture; diagram 200b shows the per-layer conditioning described throughout this specification where different embeddings p1, p2, p3, p4, p5 are provided as (part of) inputs to different layers of a diffusion model that similarly has a U-net architecture. p1, p2, p3, p4, p5 generally differ from each other, i.e., include different numeric values than each other.

The different conditioning inputs for the multiple layers of the diffusion model 120 are generated by using the per-layer conditioning engine 130 of FIG. 1, which can be configured to generate the different conditioning inputs from the system input in many different ways.

If the input text 102 describes one or more aspects for the output image 152, the per-layer conditioning engine 130 can partition the input text 102 into multiple text segments, where each text segment describes a respective aspect for the output image 152, and then generate the different conditioning inputs based on the multiple text segments.

Suppose, for example, the input text 102 is “green bicycle, oil painting,” the per-layer conditioning engine 130 can partition the input text 102 into a first text segment that describes a color of an object that should appear in the output image 152: “green,” a second text segment that describes an object that should appear in the output image 152: “bicycle,” and a third text segment that describes the style of the output image: “oil painting.”

In some implementations, the per-layer conditioning engine 130 can generate a conditioning input from a text segment. For example, the per-layer conditioning engine 130 can represent the text segment as a sequence of tokens from a predefined vocabulary of tokens, and then map each token to a corresponding numerical value in accordance with a predefined mapping. The vocabulary of tokens can include, e.g., characters, n-grams, word pieces, words, or a combination thereof.

For example, in FIG. 1B, the first conditioning input 134 can be generated from the first text segment “green,” the second conditioning input 136 can be generated from the second text segment “bicycle,” and so on.

In some implementations, the per-layer conditioning engine 130 can generate a conditioning input from two or more text segments. For example, the per-layer conditioning engine 130 can generate a combination, e.g., a permutation, of two or more text segments from the multiple text segments generated from the input text 102, and similarly represent the combination as a sequence of tokens, and then map each token to a corresponding numerical value in accordance with a predefined mapping.

A “permutation” refers to a distinct arrangement of one or more items (text segments) in a set. In those implementations, the per-layer conditioning engine 130 can thus generate different conditioning inputs by arranging the same set of two or more text segments in different positions relative to each other.

The per-layer conditioning engine 130 can generate the conditioning input by including the numerical values in the conditioning input. Alternatively, the per-layer conditioning engine 130 can process the numerical values using a text encoder neural network to generate an encoded representation of the numerical values, and then use the encoded representation of the numerical values as the conditioning input. For example, the text encoder neural network can be a fully connected neural network or an attention neural network that has been pre-trained on a text training dataset.

For example, in FIG. 1B, the first conditioning input 134 can be generated from a first permutation of text segments “green bicycle” the second conditioning input 136 can be generated from a second permutation of text segments “bicycle oil painting,” and so on.

If the system input includes one or more input images 104 the per-layer conditioning engine 130 can generate the different conditioning inputs based on the one or more input images 104.

Suppose, for example, the one or more input images 104 includes a first input image that includes a depiction of a kitten and a second input image that includes a depiction of a cup, the per-layer conditioning engine 130 can generate a first conditioning input based on the first input image and a second conditioning input based on the second input image.

In some implementations, the per-layer conditioning engine 130 can generate the corresponding conditioning input for an input image by processing the input image, data derived from the input image, e.g., a plurality of patches of the input image, or both using an image encoder neural network to generate an embedding, e.g., which includes a respective patch embedding for each of the plurality of patches in the image. Such an embedding can then be used as the corresponding conditioning input.

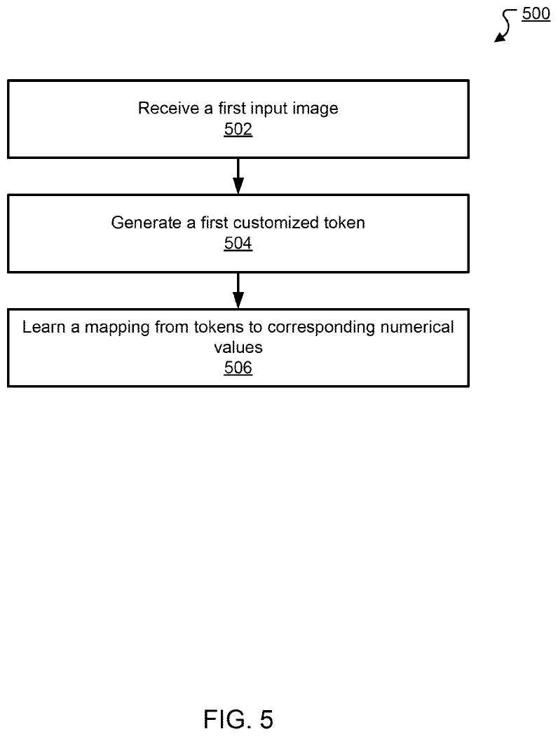

For example, in FIG. 1B, the first conditioning input 134 can be generated from the first input image that includes a depiction of a kitten, the second conditioning input 136 can be generated from the second input image that includes a depiction of a cup, and so on. In some implementations, the per-layer conditioning engine 130 can generate the corresponding conditioning input for an input image using other techniques. One example of such techniques is applying textual inversion on each of the one or more input images 104 to generate a corresponding conditioning input for the input image. In this example, the per-layer conditioning engine 130 generates a customized token for the input image, and then use the input image to determine numerical values that correspond to the customized token for inclusion in the conditioning input. Applying textual inversion on input images included in a system input to generate the conditioning inputs is described in more detail below with reference to FIG. 5.

As mentioned above, different conditioning inputs are provided to different layers of the diffusion model 120 at each of multiple time steps in the reverse diffusion process. In implementations the image generation system 100 can determine which conditioning input to provide to which layer of the diffusion model 120 in any of a variety of ways, e.g., based on the content included in the system input, based on the architecture of the diffusion model 120, based on empirical data indicating the degree of control each layer of the diffusion model 120 has over certain aspects of an output image, and so on.

Continuing with one of the examples above where the first conditioning input 134 is generated from the first text segment “green” and the second conditioning input 136 is generated from the second text segment “bicycle,” the image generation system 100 can provide, at any given time step, a first layer input that includes (i) the first conditioning input 134 and (ii) the output of a preceding layer (that precedes the first neural network layer 124) to the first neural network layer 124, and provide (i) the second conditioning input 136 and (ii) the output of a preceding layer (that precedes the second neural network layer 126) to the second neural network layer 126.

In this example, because the first conditioning input 134 generated from the first text segment “green” and the second conditioning input 136 generated from the second text segment “bicycle” were used to “guide” different layers of the diffusion model 120 during the reverse diffusion process across the multiple time steps, the output image 152 will more closely have the one or more attributes characterized by the system input, e.g., the output image 152 will more accurately show a green bicycle.

Continuing with another example above where the first conditioning input 134 is generated from the first input image that includes a depiction of a kitten and the second conditioning input 136 is generated from the second input image that includes a depiction of a cup, the image generation system 100 can provide, at any given time step, a first layer input that includes (i) the first conditioning input 134 and (ii) the output of a preceding layer (that precedes the first neural network layer 124) to the first neural network layer 124, and provide (i) the second conditioning input 136 and (ii) the output of a preceding layer (that precedes the second neural network layer 126) to the second neural network layer 126.

In this example, because the first conditioning input 134 generated from the first input image that includes a depiction of a kitten and the second conditioning input 136 generated from the second input image that includes a depiction of a cup were used to “guide” different layers of the diffusion model 120 during the reverse diffusion process across the multiple time steps, the output image 152 will more closely have the one or more attributes characterized by the system input, e.g., the output image 152 will show a cup that is in the shape of a kitten. The examples below will generally discuss generating an output image based on providing two different conditioning inputs to two different layers of the diffusion model. However, the same techniques can also be applied to generate an output image based on providing any number of different conditioning inputs, e.g., three different conditioning inputs, four different conditioning inputs, five different conditioning inputs, and so on, to different layers of the diffusion model.

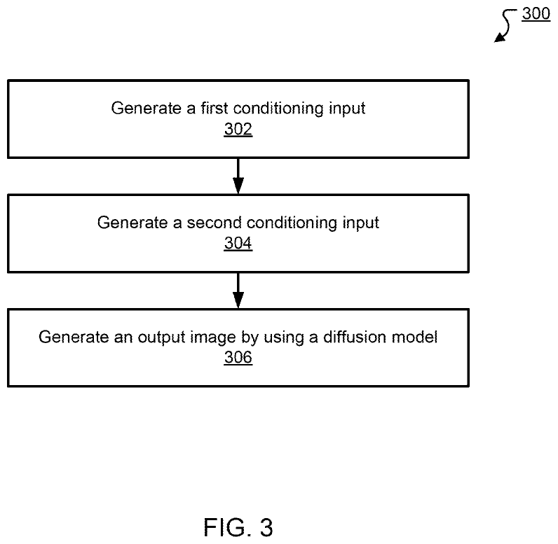

FIG. 3 is a flow diagram of an example process 300 for generating an output image by using a diffusion model. For convenience, the process 300 will be described as being performed by a system of one or more computers located in one or more locations. For example, an image generation system, e.g., the image generation system 100 of FIG. 1, appropriately programmed in accordance with this specification, can perform the process 300.

The system generates a first conditioning input from a system input (step 302). The system input includes input text and, in some implementations, one or more input images. The first conditioning input is given in the form of one or more embeddings. Each embedding can be generated from one or more tokens, e.g., one or more tokens generated from the input text, or one or more tokens generated from each of the one or more input images.

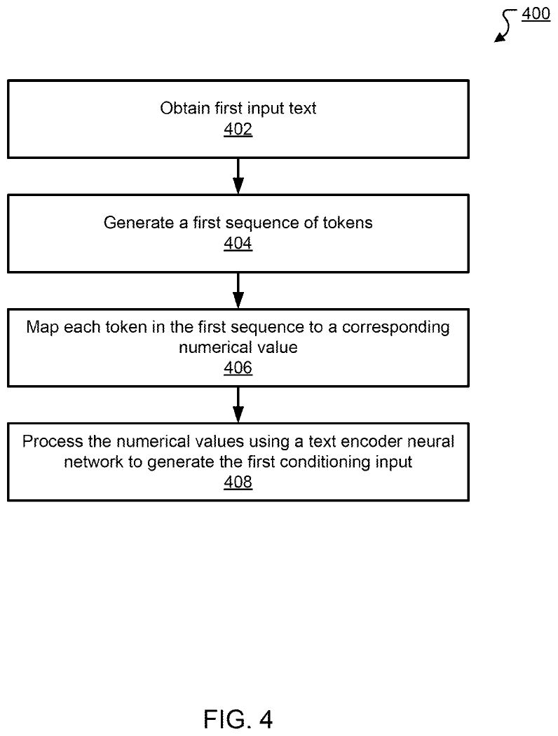

In some implementations, the system can generate the first conditioning input by performing one iteration of the process 400 described in FIG. 4, which shows sub-steps 402-408 to perform step 302.

The system obtains first input text (step 402). The first input text can be any text segment of the input text included in the system input. For example, the system can partition the input text included in the system input into multiple text segments, and select one of the multiple text segments as the first input text.

The system applies a tokenizer to the first input text to generate a first sequence of tokens that are each selected from a predefined vocabulary of tokens (step 404). The vocabulary of tokens can include, e.g., characters, n-grams, word pieces, words, or a combination thereof.

The system converts each token in the first sequence into a discrete one-hot vector, and maps, in accordance with a predefined mapping, the discrete one-hot vector to a corresponding embedding vector that includes one or more numerical values for the token (step 406).

The system processes the numerical values using a text encoder neural network to generate a first encoded representation of the numerical values (step 408). The first encoded representation is then used as the first conditioning input. For example, the text encoder neural network can be a fully connected neural network or an attention neural network that has been pre-trained on a text training dataset.

In some implementations, the system can generate the first conditioning input by performing one iteration of the process 500 described in FIG. 5, which shows sub-steps 502-508 to perform step 302.

The system receives a first set of input images (step 502). The first set of input images can be a subset of the images included in the system input. The first set of input images can each depict a subject instance.

The system generates a first customized token based on the first set of input images (step 504). The first customized token can be a new token that is not in the predefined vocabulary of tokens, i.e., it can be different from any existing token included in the predefined vocabulary. For example, when the predefined vocabulary include tokens that represent sub-words in English, the first customized token can be a new token that replaces one of the constituent letters of a particular existing token with a different letter, such that the new token represents a new sub-word that was previously not included in the predefined vocabulary.

The system uses the first set of images included in the system input to learn a mapping from tokens that include (i) the first customized token and (ii) the predefined vocabulary of tokens, to corresponding numerical values (step 506). That is, the mapping includes (i) a new mapping between the first customized token and a first embedding that corresponds to the first customized token and (ii) an updated mapping between the tokens included in the predefined vocabulary and their corresponding (updated) embeddings. After having learned the mapping, the system can map the first customized token to a corresponding embedding in accordance with the learned mapping, and then use the corresponding embedding as the first conditioning input.

The system can learn this mapping by optimizing a reconstruction objective function that evaluates, for each image in the one or more images, a difference between (i) a noise that has been added to the image to generate a noisy image and (ii) a noise prediction generated by the diffusion model from processing the noisy image and the conditioning input generated from the image.

For example, the reconstruction objective function can evaluate an extended textual inversion (XTI) loss as follows:

$${ℒ}_{XTI} = {𝔼}_{\begin{matrix}P \sim \prod , I \sim ℐ , \\ ε \sim 𝒩 ( i ) , 1 ) , t\end{matrix}} {‖ ε - {ε}_{θ} ( {I}_{t} \vert t , P ( {t}_{1} , … , {t}_{n} ) ) ‖}_{2}^{2}$$

where P represents the extended conditioning space that includes tokens t₁, . . . , tₙ, e₁, . . . , eₙ are the embeddings (that each include numerical values) that correspond respectively to the tokens t₁, . . . , tₙ, θ represents a set of parameters of the diffusion model, Iₜ is the image I (or an intermediate representation of the image I) selected from the first set of input images that includes noise ε added to the image I, and the noise ε is determined according to the noise level t.

By applying the reconstruction objective function in this example, the system can learn the numerical values of the embeddings that can optimize, i.e., minimize, the XTI loss evaluated using the reconstruction objective function. In some implementations, the parameter values of the diffusion model can be held fixed during process 500.

The system generates a second conditioning input from the system input (step 304). The second conditioning input is given in the form of one or more embeddings. The second conditioning input is different from the first conditioning input, e.g., they can be respective embeddings that include different numeric values.

In some implementations, the system can generate the second conditioning input by similarly performing one iteration of the process 400 described in FIG. 4. That is, the system obtains second input text, e.g., by partitioning the input text included in the system input into multiple text segments, and selecting one of the multiple text segments as the second input text; generating a second sequence of tokens from the second input text, where each token is selected from the predefined vocabulary of tokens; mapping each token in the second sequence to a corresponding numerical value in accordance with the predefined mapping; and processing the numerical values using the text encoder neural network to generate a second encoded representation of the numerical values that is used as the second conditioning input.

In some implementations, the system can generate the second conditioning input by similarly performing one iteration of the process 500 described in FIG. 5. That is, the system receives a second set of input images which can be another subset of the images included in the system input; generates a second customized token based on the second set of input images; and uses the second set of input images included in the system input to learn a mapping from tokens that include (i) the second customized token and (ii) the predefined vocabulary of tokens, to corresponding embeddings.

In some implementations, the system can generate the first and second conditioning inputs together by performing one iteration of the process 500 described in FIG. 5. That is, the mapping learned by the system by using a set of input images is a mapping from tokens that include both (i) the first customized token, (ii) the second customized token, and (ii) the predefined vocabulary of tokens, to corresponding embeddings.

Like the first customized token, the second customized token can be a new token that is not in the predefined vocabulary of tokens, i.e., it can be different from any existing token included in the predefined vocabulary. After having learned the mapping, the system can map, in accordance with the learned mapping, the second customized token to the corresponding embedding to be used as the second conditioning input.

The system generates an output image by using a diffusion model (step 306). The diffusion model includes multiple neural network layers. The multiple neural network layers include a first neural network layer followed by a second neural network layer.

To generate the output image, the system iteratively uses the diffusion model to update a latent representation of the output image at each of multiple time steps over a reverse diffusion process, and iteratively provides different conditioning inputs to different layers of the diffusion model, e.g., provides the first conditioning input to the first neural network layer and provides the second conditioning input to the second neural network layer, as a guidance to guide the diffusion model at each of the multiple time steps.

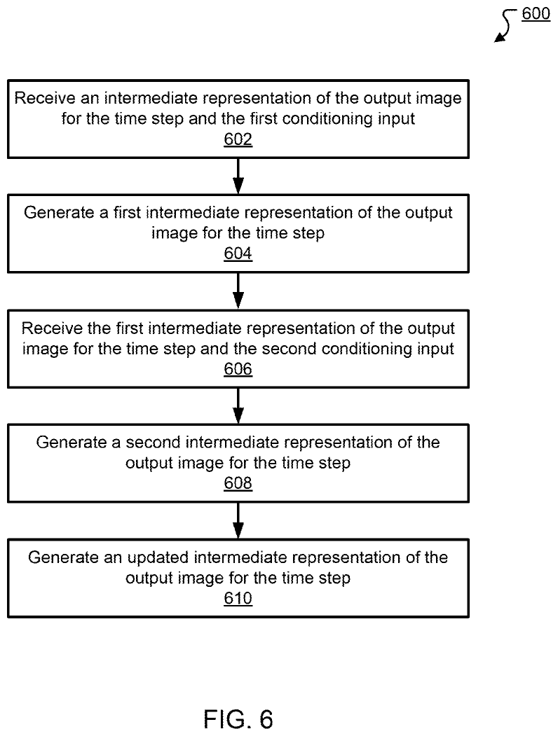

Generating the output image is described with reference to FIG. 6, which is an example illustration 600 of updating an intermediate representation of the output image.

FIG. 6 is a flow diagram of an example process 600 for updating an intermediate representation of the output image. For convenience, the process 600 will be described as being performed by a system of one or more computers located in one or more locations. For example, an image generation system, e.g., the image generation system 100 of FIG. 1, appropriately programmed in accordance with this specification, can perform the process 600.

Process 600 can be performed at each of multiple time steps over the over the reverse diffusion process. In other words, the system generates the output image by repeatedly, i.e., at each of the multiple time steps, performing an iteration of the process 600 to update an intermediate representation of the output image. The final output image is the updated intermediate representation generated in the last iteration of the process 600. In some situations, the multiple iterations of the process 600 can be collectively referred to as a reverse diffusion process, with one iteration of the process 600 being performed at each time step during the reverse diffusion process.

The system receives, by the first neural network layer of the diffusion model, an intermediate representation of the output image for the time step and the first conditioning input (step 602). The intermediate representation of the output image can generally be or include the output generated by a preceding layer of the diffusion model based at least in part on a current intermediate representation of the output image for the time step.

The system generates, by the first neural network layer of the diffusion model, a first intermediate representation of the output image for the time step based on processing the intermediate representation of the output image for the time step and the first conditioning input (step 604).

For example, the first neural network layer can be a cross-attention layer of the diffusion model. The cross-attention layer receives a layer input that includes the intermediate representation of the output image for the time step (that is generated by a preceding layer) and the first conditioning input, and generates a layer output by applying a cross-attention mechanism between the intermediate representation and the first conditioning input. As a particular example of this, the cross-attention mechanism can use queries derived from the intermediate representation that is generated by the preceding layer, and keys (and, optionally) values derived from the first conditioning input, where each query, key, or value is a vector. The layer output of the cross-attention layer can then be used as the first intermediate representation of the output image for the time step.

The system receives, by the second neural network layer of the diffusion model, the first intermediate representation of the output image for the time step and the second conditioning input (step 606). The first intermediate representation is generated by the first neural network layer of the diffusion model. The second conditioning input is different from the first conditioning input that was processed by the first neural network layer when generating the first intermediate representation.

The system generates, by the second neural network layer of the diffusion model, a second intermediate representation of the output for the time step based on processing the first intermediate representation of the output image for the time step and the second conditioning input (step 608).

For example, the second neural network layer can be another cross-attention layer of the diffusion model. The cross-attention layer receives a layer input that includes the first intermediate representation of the output image for the time step (that is generated by the first neural network layer) and the second conditioning input, and generates a layer output by applying a cross-attention mechanism between the first intermediate representation and the second conditioning input. The layer output of the cross-attention layer can then be used as the second intermediate representation of the output image for the time step.

In some implementations, the first cross-attention layer and the second cross-attention layer correspond to the same spatial resolution level, i.e., the first intermediate representation has the same spatial resolution as the second intermediate representation. In other implementations, the first cross-attention layer and the second cross-attention layer correspond to different spatial resolution levels, i.e., the first intermediate representation and the second intermediate representation have different spatial resolutions. For example, the first cross-attention layer corresponds to a first spatial resolution level, and the second cross-attention layer corresponds to a second spatial resolution level that is higher than the first spatial resolution level.

The system generates an updated intermediate representation of the output image for the time step based at least in part on the second intermediate representation of the output for the time step (step 610). For example, the system processes the second intermediate representation of the output for the time step using subsequent layers of the diffusion model to generate a diffusion model output for the time step from which the updated intermediate representation can be inferred.

In some implementations, the diffusion model output can define a prediction of a noise that needs to be added to the output image being generated by the system, to generate the current intermediate representation, and the updated intermediate representation can be generated by using the predicted noise to de-noise the current intermediate representation, i.e., by removing the predicted noise from the current intermediate representation.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:
Clause 1. A computer-implemented method comprising:
   generating a first token embedding;
   generating a second token embedding that is different from the first token embedding;
   generating an output image by using a diffusion model comprising multiple neural network layers, wherein the multiple neural network layers comprise a first neural network layer followed by a second neural network layer, and wherein the generating comprises, at each of multiple time steps:
      receiving, by the first neural network layer of the diffusion model, an intermediate representation of the output image for the time step and the first token embedding;
      generating, by the first neural network layer of the diffusion model, a first intermediate representation of the output image for the time step based on processing the intermediate representation of the output image for the time step and the first token embedding;
      receiving, by the second neural network layer of the diffusion model, the first intermediate representation of the output image for the time step and the second token embedding;
      generating, by the second neural network layer of the diffusion model, a second intermediate representation of the output for the time step based on processing the first intermediate representation of the output image for the time step and the second token embedding; and
      generating an updated intermediate representation of the output image for the time step based at least in part on the second intermediate representation of the output for the time step.
Clause 2. The method of claim 1, wherein generating the updated intermediate representation of the output image for the time step comprises:
   processing the second intermediate representation of the output for the time step using subsequent layers of the diffusion model to generate a noise prediction; and
   using the noise prediction to de-noise the intermediate representation of the output image for the time step.
Clause 3. The method of any one of clauses 1-2, wherein:
   the first and second neural network layers are each a respective cross-attention layer;
   generating, by the first neural network layer of the diffusion model, the first intermediate representation of the output image for the time step comprises applying a cross-attention attention mechanism over the intermediate representation of the output image for the time step and the first token embedding; and
   generating, by the second neural network layer of the diffusion model, the second intermediate representation of the output for the time step based on applying a cross-attention attention mechanism over the first intermediate representation of the output image for the time step and the second token embedding.
Clause 4. The method of clause 3, wherein the first cross-attention layer corresponds to a first spatial resolution level, and the second cross-attention layer corresponds to a second spatial resolution level that is higher than the first spatial resolution level.
Clause 5. The method of any one of clauses 3-4, wherein the cross-attention mechanism of the first attention layer uses one or more keys derived from the first token embedding.
Clause 6. The method of any one of clauses 1-5, wherein generating the first token embedding comprise:
   obtaining first input text;
   generating, from the first input text, a first sequence of tokens that are each selected from a predefined vocabulary of tokens;
   mapping each token in the first sequence to a corresponding numerical value in accordance with a predefined mapping; and
   processing the numerical values using a text encoder neural network to generate the first token embedding.
Clause 7. The method of any one of clauses 1-6, wherein generating the second token embedding comprise:
   obtaining second input text;
   generating, from the first input text, a second sequence of tokens that are each selected from the predefined vocabulary of tokens;
   mapping each token in the second sequence to a corresponding numerical value in accordance with the predefined mapping; and
   processing the numerical values using the text encoder neural network to generate the second token embedding.
Clause 8. The method of any one of clauses 6-7, wherein the first and second input text each describe a different aspect of the output image.
Clause 9. The method of any one of clauses 1-8, further comprising:
   receiving a set of images that each depict a subject instance;
   generating a first customized token for the first neural network layer and a second customized token for the second neural network layer, wherein first customized token and the second customized token are not in the predefined vocabulary of tokens; and
   using the set of images to update a mapping from tokens that include (i) the first and second customized tokens and (ii) the predefined vocabulary of tokens to numerical values based on optimizing a reconstruction objective function that evaluates, for each image in the set of images, a difference between (i) a noise that has been added to the image to generate a noisy image and (ii) a noise prediction generated by the diffusion model from processing the noisy image,
   wherein, when processing each image, the first neural network layer of the diffusion model receives a token embedding generated from the first customized token and the second neural network layer of the diffusion model receives a token embedding generated from the second customized token.
Clause 10. A system comprising one or more computers and one or more storage devices storing instructions that are operable, when executed by the one or more computers, to cause the one or more computers to perform the operations of the respective method of any preceding clause.
Clause 11. A computer storage medium encoded with instructions that, when executed by one or more computers, cause the one or more computers to perform the operations of the respective method of any preceding clause.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
generating a first token embedding;
generating a second token embedding that is different from the first token embedding;
generating an output image by using a diffusion model comprising multiple neural network layers, wherein the multiple neural network layers comprise a first neural network layer followed by a second neural network layer, and wherein the generating comprises, at each of multiple time steps:
receiving, by the first neural network layer of the diffusion model, an intermediate representation of the output image for the time step and the first token embedding;
generating, by the first neural network layer of the diffusion model, a first intermediate representation of the output image for the time step based on processing the intermediate representation of the output image for the time step and the first token embedding;
receiving, by the second neural network layer of the diffusion model, the first intermediate representation of the output image for the time step and the second token embedding;
generating, by the second neural network layer of the diffusion model, a second intermediate representation of the output for the time step based on processing the first intermediate representation of the output image for the time step and the second token embedding; and
generating an updated intermediate representation of the output image for the time step based at least in part on the second intermediate representation of the output for the time step.

2. The method of claim 1, wherein generating the updated intermediate representation of the output image for the time step comprises:
processing the second intermediate representation of the output for the time step using subsequent layers of the diffusion model to generate a noise prediction; and
using the noise prediction to de-noise the intermediate representation of the output image for the time step.

3. The method of claim 1, wherein:
the first and second neural network layers are each a respective cross-attention layer;
generating, by the first neural network layer of the diffusion model, the first intermediate representation of the output image for the time step comprises applying a cross-attention attention mechanism over the intermediate representation of the output image for the time step and the first token embedding; and
generating, by the second neural network layer of the diffusion model, the second intermediate representation of the output for the time step based on applying a cross-attention attention mechanism over the first intermediate representation of the output image for the time step and the second token embedding.

4. The method of claim 3, wherein the first cross-attention layer corresponds to a first spatial resolution level, and the second cross-attention layer corresponds to a second spatial resolution level that is higher than the first spatial resolution level.

5. The method of claim 1, wherein the cross-attention mechanism of the first attention layer uses one or more keys derived from the first token embedding.

6. The method of claim 1, wherein generating the first token embedding comprise:
obtaining first input text;
generating, from the first input text, a first sequence of tokens that are each selected from a predefined vocabulary of tokens;
mapping each token in the first sequence to a corresponding numerical value in accordance with a predefined mapping; and
processing the numerical values using a text encoder neural network to generate the first token embedding.

7. The method of claim 1, wherein generating the second token embedding comprise:
obtaining second input text;
generating, from the second input text, a second sequence of tokens that are each selected from the predefined vocabulary of tokens;
mapping each token in the second sequence to a corresponding numerical value in accordance with the predefined mapping; and
processing the numerical values using the text encoder neural network to generate the second token embedding.

8. The method of claim 6, wherein the first and second input text each describe a different aspect of the output image.

9. The method of claim 1, further comprising:
receiving a set of images that each depict a subject instance;
generating a first customized token for the first neural network layer and a second customized token for the second neural network layer, wherein first customized token and the second customized token are not in the predefined vocabulary of tokens; and
using the set of images to update a mapping from tokens that include (i) the first or second customized tokens and (ii) the predefined vocabulary of tokens to numerical values based on optimizing a reconstruction objective function that evaluates, for each image in the set of images, a difference between (i) a noise that has been added to the image to generate a noisy image and (ii) a noise prediction generated by the diffusion model from processing the noisy image,
wherein, when processing each image, the first neural network layer of the diffusion model receives a token embedding generated from the first customized token and the second neural network layer of the diffusion model receives a token embedding generated from the second customized token.

10. A system comprising one or more computers and one or more storage devices storing instructions that are operable, when executed by the one or more computers, to cause the one or more computers to perform operations comprising:
generating a first token embedding;
generating a second token embedding that is different from the first token embedding;
generating an output image by using a diffusion model comprising multiple neural network layers, wherein the multiple neural network layers comprise a first neural network layer followed by a second neural network layer, and wherein the generating comprises, at each of multiple time steps:
receiving, by the first neural network layer of the diffusion model, an intermediate representation of the output image for the time step and the first token embedding;
generating, by the first neural network layer of the diffusion model, a first intermediate representation of the output image for the time step based on processing the intermediate representation of the output image for the time step and the first token embedding;
receiving, by the second neural network layer of the diffusion model, the first intermediate representation of the output image for the time step and the second token embedding;
generating, by the second neural network layer of the diffusion model, a second intermediate representation of the output for the time step based on processing the first intermediate representation of the output image for the time step and the second token embedding; and
generating an updated intermediate representation of the output image for the time step based at least in part on the second intermediate representation of the output for the time step.

11. A non-transitory computer storage medium encoded with instructions that, when executed by one or more computers, cause the one or more computers to perform operations comprising:
generating a first token embedding;
generating a second token embedding that is different from the first token embedding;
generating an output image by using a diffusion model comprising multiple neural network layers, wherein the multiple neural network layers comprise a first neural network layer followed by a second neural network layer, and wherein the generating comprises, at each of multiple time steps:
receiving, by the first neural network layer of the diffusion model, an intermediate representation of the output image for the time step and the first token embedding;
generating, by the first neural network layer of the diffusion model, a first intermediate representation of the output image for the time step based on processing the intermediate representation of the output image for the time step and the first token embedding;
receiving, by the second neural network layer of the diffusion model, the first intermediate representation of the output image for the time step and the second token embedding;
generating, by the second neural network layer of the diffusion model, a second intermediate representation of the output for the time step based on processing the first intermediate representation of the output image for the time step and the second token embedding; and
generating an updated intermediate representation of the output image for the time step based at least in part on the second intermediate representation of the output for the time step.

12. The system of claim 10, wherein generating the updated intermediate representation of the output image for the time step comprises:
processing the second intermediate representation of the output for the time step using subsequent layers of the diffusion model to generate a noise prediction; and
using the noise prediction to de-noise the intermediate representation of the output image for the time step.

13. The system of claim 10, wherein:
the first and second neural network layers are each a respective cross-attention layer;
generating, by the first neural network layer of the diffusion model, the first intermediate representation of the output image for the time step comprises applying a cross-attention attention mechanism over the intermediate representation of the output image for the time step and the first token embedding; and
generating, by the second neural network layer of the diffusion model, the second intermediate representation of the output for the time step based on applying a cross-attention attention mechanism over the first intermediate representation of the output image for the time step and the second token embedding.

14. The system of claim 13, wherein the first cross-attention layer corresponds to a first spatial resolution level, and the second cross-attention layer corresponds to a second spatial resolution level that is higher than the first spatial resolution level.

15. The system of claim 10, wherein the cross-attention mechanism of the first attention layer uses one or more keys derived from the first token embedding.

16. The system of claim 10, wherein generating the first token embedding comprise:
obtaining first input text;
generating, from the first input text, a first sequence of tokens that are each selected from a predefined vocabulary of tokens;
mapping each token in the first sequence to a corresponding numerical value in accordance with a predefined mapping; and
processing the numerical values using a text encoder neural network to generate the first token embedding.

17. The system of claim 10, wherein generating the second token embedding comprise:
obtaining second input text;
generating, from the second input text, a second sequence of tokens that are each selected from the predefined vocabulary of tokens;
mapping each token in the second sequence to a corresponding numerical value in accordance with the predefined mapping; and
processing the numerical values using the text encoder neural network to generate the second token embedding.

18. The system of claim 17, wherein the first and second input text each describe a different aspect of the output image.

19. The system of claim 10, wherein the operations further comprise:
receiving a set of images that each depict a subject instance;
generating a first customized token for the first neural network layer and a second customized token for the second neural network layer, wherein first customized token and the second customized token are not in the predefined vocabulary of tokens; and
using the set of images to update a mapping from tokens that include (i) the first or second customized tokens and (ii) the predefined vocabulary of tokens to numerical values based on optimizing a reconstruction objective function that evaluates, for each image in the set of images, a difference between (i) a noise that has been added to the image to generate a noisy image and (ii) a noise prediction generated by the diffusion model from processing the noisy image,
wherein, when processing each image, the first neural network layer of the diffusion model receives a token embedding generated from the first customized token and the second neural network layer of the diffusion model receives a token embedding generated from the second customized token.

20. The computer storage medium of claim 11, wherein generating the updated intermediate representation of the output image for the time step comprises:
processing the second intermediate representation of the output for the time step using subsequent layers of the diffusion model to generate a noise prediction; and
using the noise prediction to de-noise the intermediate representation of the output image for the time step.
